(19) United States
(12) Patent Application Publication
(10) Pub. No.: US 2018/0014913 A1
(43) Pub. Date: Jan. 18, 2018

(54) COMPOSITE RESTORATION MATRIX BAND

(71) Applicant: King Abdulaziz University, Jeddah (SA)

(72) Inventor: Fahad Ibrahim FATINY, Jeddah (SA)

(73) Assignee: King Abdulaziz University, Jeddah (SA)

(21) Appl. No.: 15/209,139

(22) Filed: Jul. 13, 2016

(51) Int. Cl. A61C 5/12

(52) U.S. Cl. CPC A61C 5/125

(57) ABSTRACT

A V-shaped plastic dental matrix band having an elongate body with first and second ends, a central portion between the first and second ends, and a collar portion on top of the central portion. The plastic dental matrix band tapers in thickness from thick first and second ends to a thin central portion, thereby providing a snug fit and tight contact with the tooth. The thick first and second ends are adapted to provide a bearing surface for the clamping screws of a matrix band retainer. The thickness of the collar portion is the same as that of the first and second ends and tapers from a top of the collar portion to a shared border with the central portion.

### BACKGROUND OF THE INVENTION

### Field of the Invention

This disclosure relates to dental implements, and particularly to a matrix band that can be used with a dental matrix retainer to provide a temporary mold when repairing the crown of a tooth or other dental restorations.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The TOFFLEMIRE matrix system, developed by Dr. Joseph Tofflemire, includes a dental matrix band that is formed into a loop around a tooth and held in place by a clamp referred to as a TOFFLEMIRE Universal retainer to provide a temporary mold that the dentist fills with an amalgam, composite, or other matrix material when repairing the tooth. The dental matrix band is used to temporarily replace missing parts of a prepared tooth and to confine restorative material to an area or areas prepared to receive the restorative material. The dental matrix band in the TOFFLEMIRE matrix system is typically made from a metal, such as stainless steel, and generally forms a funnel shape when formed into a loop in order to conform to the small circumference gingival surfaces and larger circumference occlusal surfaces of the tooth.

Currently, celluloid or similar light transmissive polymeric band materials are being used in place of metal, especially in the situations where it is desired to use polymeric materials, such as UV-hardening resins, for reconstructive purposes. However, this type of band is, by its very nature, uniformly thin along its entire length, flexible, and tends to be smooth and therefore somewhat slippery and difficult to manipulate. Such polymeric bands are difficult to position in TOFFLEMIRE Universal retainers and other similar matrix retainers, and also may slip during band tightening, for example. Because of these problems, TOFFLEMIRE Universal retainers and other similar dental matrix band retainers and clamps continue to use only metal matrix bands.

In view of the foregoing, one objective of the present disclosure is to provide a plastic dental matrix band which is designed to overcome the aforementioned challenges.

### SUMMARY OF THE DISCLOSURE

The foregoing description is intended to provide a general introduction and summary of the present disclosure and is not intended to be limiting in its disclosure unless otherwise explicitly stated. The presently preferred embodiments, together with further advantages, will be best understood by reference to the following detailed description taken in conjunction with the accompanying drawings.

A first aspect of the disclosure relates to a dental matrix band, comprising: (i) a first end and a second end each comprising an interior face and an exterior face, (ii) a central portion comprising transparent plastic disposed between the first end and the second end, wherein the central portion is elongated and inclined at an obtuse angle, and (iii) a collar portion that connects the first end and the second end, wherein the collar portion borders a top of and extends in a parallel direction to the central portion, and tapers in a thickness from a top of the collar portion to a shared border with the central portion, wherein the first end, the second end, the central portion, and the collar portion form a unitary construction when connected which tapers in a thickness from the first end and the second end to the central portion, and wherein the dental matrix band is flexible and is configured to form a loop by connecting the interior faces of the first end and the second end and clamping the exterior faces of the first end and the second end by a dental matrix retainer.

In one embodiment, an edge of each of the first end and the second end is rounded.

In one embodiment, the first end and the second end have a thickness ranging from 0.038-0.13 mm and a width ranging from 6-10 mm.

In one embodiment, the exterior faces of the first and second ends comprise a frictional engagement surface to securely attach the first end and the second end to a clamping screw of the dental matrix retainer.

In one embodiment, the central portion has a thickness ranging from 0.0025-0.026 mm, a width ranging from 6-10 mm, and a longitudinal half-length ranging from 20-25 mm.

In one embodiment, the obtuse angle ranges from 120-150°.

In one embodiment, the obtuse angle ranges from 130-140°.

In one embodiment, the collar portion further comprises an interior face, an exterior face, and a frictional engagement surface disposed on the exterior face.

In one embodiment, the collar portion comprises a first curved portion connected to the first end of the dental matrix band and a second curved portion connected to the second end of the dental matrix band.

In one embodiment, the collar portion has a width ranging from 1-5 mm, a half-length ranging from 20-25 mm, and a thickness ranging from 0.038-0.13 mm.

In one embodiment, the collar portion has a width ranging from 1-3 mm.

In one embodiment, the dental matrix band has a longitudinal half-length of 25-35 mm.

In one embodiment, the first end, the second end, and the collar portion comprise a biocompatible flexible plastic.

In one embodiment, the biocompatible flexible plastic is polyester or nylon.

In one embodiment, the first end, the second end, and the collar portion are opaque.

In one embodiment, the dental matrix band does not contain a metal.

In one embodiment, the central portion comprises an interior face and an exterior face, and the central portion is flat between a middle of the central portion to the first end and the second end.

In one embodiment, a bottom of the central portion is straight between a middle of the central portion to the first end and the second end.

A second aspect of the disclosure relates to a dental matrix kit, comprising a dental matrix retainer and the dental matrix band of the first aspect.

### BRIEF DESCRIPTION OF THE DRAWINGS

FIG. 1 shows an embodiment of the dental matrix band.

FIG. 2 shows another embodiment of the dental matrix band.

FIG. 3 is a perspective view of the dental matrix band of FIG. 2.

FIG. 4 is an expanded view of the dental matrix band of FIG. 2.

FIG. 5 shows a cross-section of the dental matrix band of FIG. 2.

FIG. 6 is a top view of an embodiment of the dental matrix band.

FIG. 7 is a perspective view of a TOFFLEMIRE Universal matrix retainer.

FIG. 8 is a top view of the dental matrix band forming a loop around a tooth before a dental restoration.

FIG. 9 is a perspective view of the dental matrix band forming a loop around the tooth before the dental restoration.

FIG. 10 is an environmental perspective view of the dental matrix band in the dental restoration.

FIG. 11 is an expanded environmental perspective view of the dental matrix band in the dental restoration.

FIG. 12 is an environmental top view of the dental matrix band in a dental restoration.

### DETAILED DESCRIPTION OF THE DISCLOSURE

Embodiments of the present disclosure will now be described more fully hereinafter with reference to the accompanying drawings, in which some, but not all embodiments of the disclosure are shown.

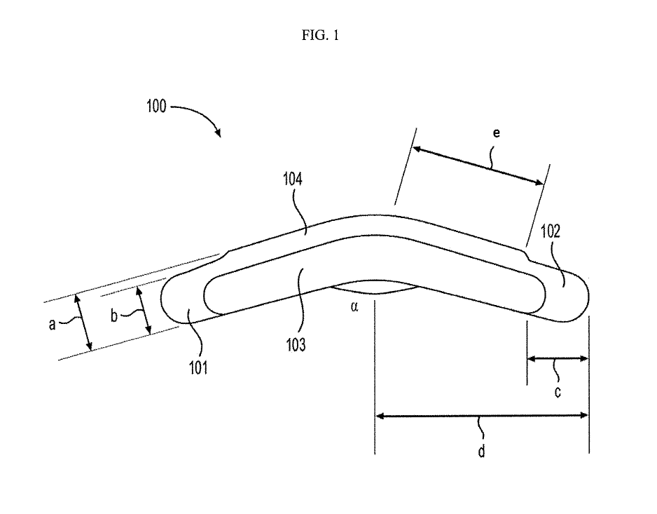

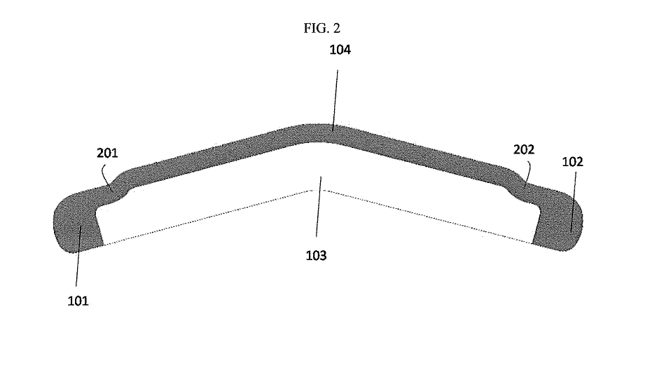

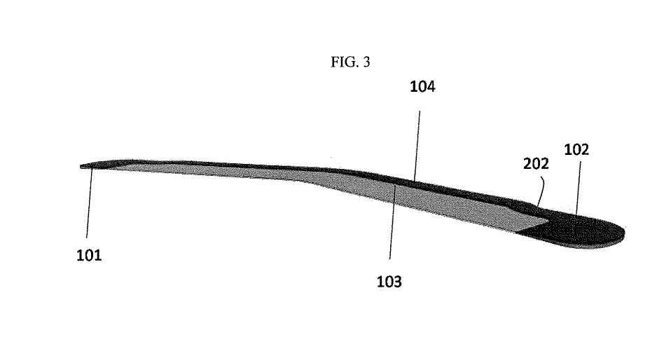

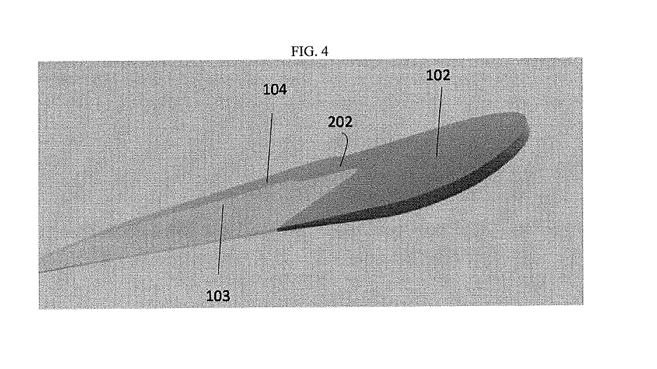

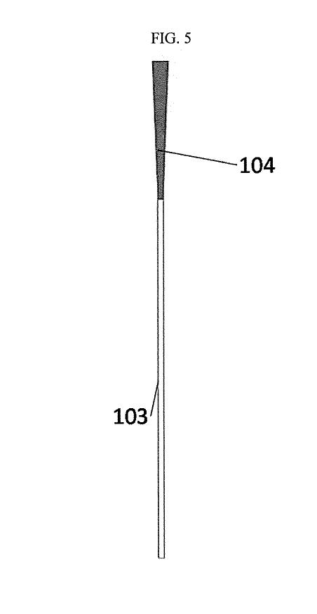

Within the description of this disclosure, where a numerical limit or range is stated, the endpoints are included unless stated otherwise. Also, all values and subranges within a numerical limit or range are specifically included as if explicitly written out. As used herein, the words “a” and “an” and the like carry the meaning of “one or more”. The dental matrix band 100 for dental restorations is depicted in FIGS. 1-6.

The dental matrix band is a flexible strip, which has a V shape or a boomerang shape. The dental matrix band has a first end 101 and a second end 102, a central portion 103 defined therebetween, and a collar 104 connecting the first and second ends and bordering the top of the central portion. In a preferred embodiment, the dental matrix band is a solid band (i.e. no holes in the band).

The dental matrix band may preferably be made of a biocompatible plastic such as polyester, or nylon. Preferably, the biocompatible plastic is Mylar™. The biocompatible plastic is preferably flexible and may have a stiffness value ranging from 100-900 kg/cm², preferably 300-900 kg/cm², more preferably 400-600 kg/cm². The stiffness of the biocompatible plastic may preferably be measured with the ASTM D1043 method. As used herein, “stiffness” refers to rigidity of an object and the extent to which it resists deformation in response to an applied force.

The central portion preferably comprises a transparent, light-transmitting plastic. In one embodiment, the light-transmitting plastic is translucent. The transparency/translucency of the central portion allows for the use of composite dental repair materials that harden in response to ultraviolet or other types of light and/or preferably transmissive to one or more of UV, visible or IR light. In the context of the present disclosure a material that permits at least 50%, 75%, 80%, 90% or 95% of light of any portion of the light spectrum to pass through the dental matrix band may be considered transmissive or transparent. The central portion may preferably be clear to transmit all wavelengths of light. In an alternative embodiment, a central portion is colored (e.g. blue) to provide a contrast between the dental matrix band and the tooth, thus offering better visual control. The first and second ends and the collar portion may be transparent, translucent, opaque, and/or colored as desired. In one embodiment, the first and second ends, and the collar portion are opaque and blue in color.

The opacity of the biocompatible plastic may be determined by the crystallinity of the biocompatible plastic. For example, crystalline polyester is opaque, while amorphous polyester is transparent. The color of the biocompatible plastic may be tailored by adding a dye to the biocompatible plastic during plastic manufacturing. The dye may have a molecular skeleton based on anthraquinone, quinoline, acenapthene, and quinophthalone. An amount of dye may range from 1-100 ppm, preferably 30-80 ppm, more preferably 40-60 ppm, based on a total weight of the biocompatible plastic.

In one embodiment, the first and second ends, and the collar portion, may be made of a different material than the central portion. For example, the central portion may be made of polyester and the collar portion, the first and second ends are made of nylon. In one embodiment, the dental matrix band does not contain a metal.

The dental matrix band has a width a ranging from 7-11 mm, preferably 8-10 mm, more preferably 8.5-9.5 mm, and a longitudinal half-length d of 25-35 mm, preferably 30-35 mm, more preferably 31-34 mm. As used herein, the term “longitudinal half-length” refers to half of the length measured along a longitudinal axis passing through the first and second ends of the dental matrix band. The V-shaped band defines an angle α ranging from 120-150°, preferably 130-140°, more preferably 134-136° such that the dental matrix band forms a funnel-shaped loop to adapt to the shape of the tooth which is being restored. The dental matrix band may be employed in dental restoration of anterior teeth, such as incisors and canine teeth, in classes III and IV restorations in which the proximal wall of an anterior tooth is missing. In a preferred embodiment, the dental matrix band is employed in dental restoration of posterior teeth such as premolars and molars.

The first and second ends each comprise an interior face and an exterior face. The exterior faces may preferably comprise a frictional engagement surface to securely attach the first end and the second end to a clamping screw of the dental matrix retainer. As used herein, the frictional engagement surface is a portion which provides increased friction. The frictional engagement surface may be textured or rough such that the first and second ends remain engaged by the dental matrix retainer throughout the dental restoration process. A surface roughness of the frictional engagement surface may range from 0.01-50 μm, preferably 5-40 μm, more preferably 15-25 μm. A roughness width of the frictional engagement surface may range from 0.01-50 μm, preferably 10-40 μm, more preferably 15-20 μm. As used herein, “roughness width” refers to a distance between successive ridges which constitute the predominate pattern of roughness. The frictional engagement surface is preferably formed by sandblasting the exterior faces to form surface features having ridges, which may be pointed or rounded. A region between adjacent ridges may be flat, concave, or convex. However, the frictional engagement surface can be formed by any suitable process.

For example, the frictional engagement surface may be formed by microetching or adhering abrasive material to the exterior faces. Exemplary abrasive materials include, but are not limited to, aluminum oxide, calcium carbonate, and silicon carbide. The abrasive material may preferably be in a form of a particle with a diameter ranging from 0.1-20 μm, preferably 1-10 μm, more preferably 1-5 μm. The abrasive particle may protrude from the surface. In one embodiment, the frictional engagement surface may be a rubber sheet irreversibly attached to the first and second ends. Adhesives, such as epoxy and silicone, may be used to attach the rubber sheet to the first and second ends. A thickness of the rubber sheet may range from 0.05-2 mm, preferably 0.1-1 mm, more preferably 0.1-0.3 mm.

The frictional engagement surface may preferably cover 100% of surface area of the exterior faces of the first and second ends. In other embodiments, the frictional engagement surface may be disposed along the edge of the exterior faces of the first and second ends and cover at least 50% of the surface area of the exterior faces, preferably at least 80%, more preferably at least 90%. In one embodiment, the interior faces of the first and second ends do not contain a frictional engagement surface.

The first and second ends of the dental matrix band may be rounded, flat, or scalloped. Preferably, the first and second ends are rounded. In one embodiment, the first and second ends are not scrolled. These ends may have a maximum thickness g ranging from 0.038-0.13 mm, preferably 0.07-0.13 mm, more preferably 0.1-0.13 mm, and a width b ranging from 6-10 mm, preferably 6-8 mm, more preferably 6.5-7.5 mm. The longitudinal length c of each of the first and seconds ends may range from 6-11 mm, preferably 7-10 mm, more preferably 7.5-8.5 mm. In one embodiment, the first and second ends have the same thickness. In another embodiment, the first end is thicker than the second end by 1.01-1.3 times, preferably 1.01-1.1 times, more preferably 1.01-1.05 times.

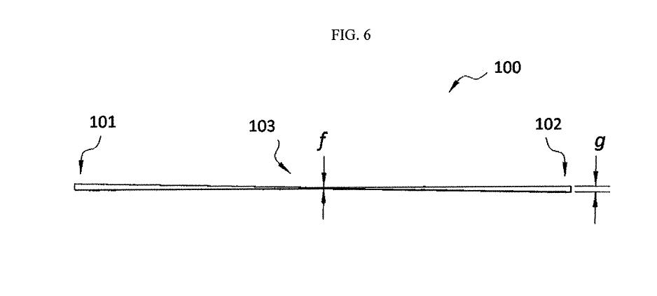

The central portion may have a thickness ranging from 0.0025-0.026 mm, preferably 0.008-0.026 mm, more preferably 0.01-0.026 mm, a width ranging from 6-10 mm, preferably 6-9 mm, more preferably 6.5-7.5 mm, and a longitudinal half-length ranging from 20-25 mm, preferably 21-25 mm, more preferably 23-25 mm. In one embodiment, the central portion has a uniform width. In another embodiment, the central portion is wider in the middle. The width of middle of the central portion may be 1.01-1.2 times the width of the edges of the central portion which borders the first and second ends, preferably 1.01-1.1 times, more preferably 1.01-1.05 times. A middle of the dental matrix band is sufficiently thin that it provides the desired flexibility while maintaining sufficient strength to permit safe and ready disposition about a tooth during dental restorations (FIG. 6). The thickness f may range from 0.0025-0.013 mm, preferably 0.005-0.013 mm, more preferably 0.01-0.013 mm. The thickness of the dental matrix band progressively increases towards the first and second ends thus producing a wedge-like configuration.

A bottom of the central portion, from the middle of the central portion to the edges of the central portion may preferably be straight. In one embodiment, the bottom of the central portion, from the middle of the central portion to the edges of the central portion is not curved.

The central portion comprises an interior face and an exterior face. The interior face of the central portion may be a smooth and/or non-stick surface so that the restoration material does not stick to the central portion. The interior face of the central portion may be irreversibly attached a thin sheet of non-stick polymer such as polytetrafluoroethylene and silicone. The aforementioned adhesives may be used to stick the thin sheet of non-stick polymer to the interior face of the central portion. A thickness of the non-stick polymer sheet may range from 0.1-2 mm, preferably 0.1-1 mm, more preferably 0.1-0.3 mm.

In a preferred embodiment, the interior and exterior faces of the central portion from the middle of the central portion to the edges of the central portion which borders the first and second ends are flat. In other embodiments, the interior and exterior faces of the central portion from the middle of the central portion to the edges of the central portion which borders the first and second ends are not curved, that is, neither concave nor convex.

A collar portion borders the top of the central portion and connects the first and second ends. The advantages of the collar portion is two-fold: (i) it may help in forming a tight and/or stable loop which does not slip and/or loosen when the dental restoration is in progress, and (ii) maintains the configuration of the tooth shape. The thickness of the collar portion may preferably be the same as the aforementioned thicknesses for the first and second ends. A width of the collar portion may range from 1-5 mm, preferably 1-3 mm, more preferably 1.5-2.5 mm. A longitudinal half-length of the collar portion may range from 20-25 mm, preferably 20-25 mm, more preferably 23-25 mm. The collar portion may comprise a first curved portion 201 connected to the first end of the dental matrix band and a second curved portion 202 connected to the second end of the dental matrix band. Each curved portion may be shaped like an arc, such as a minor arc, a major arc, or a semicircle. Preferably, each curved portion is shaped like a minor arc with a central angle ranging from 10-110°, preferably 30-80°, more preferably 40-60°. The curved portion may be positioned with the concave face of the minor arc facing toward or away from the bottom of the dental matrix band. Preferably, the concave face of the minor arc faces away from the bottom of the dental matrix band. A length e, measured along the collar portion, from one end of either curved portion to the middle of the collar portion, may range from 20-26 mm, preferably 23-26 mm, more preferably 23.5-25.5 mm. A width of the collar portion may range from 1-5 mm, preferably 1-3 mm, more preferably 1.5-2.5 mm.

In one embodiment, the collar portion is made of a light-activated shape-memory polymer which switches between an elastomer and a rigid polymer by shining light of different wavelengths. This feature may allow the dental matrix band to retain the shape and integrity of the loop formed around the tooth during dental restoration. For example, the biocompatible polymer may contain a cinnamic group which is light-responsive and hence can be fixed into the shape of the loop by shining ultraviolet-visible light (with a wavelength 260-700 nm) and then recover their original shape when exposed to light with a wavelength in the far-UV region (10-200 nm).

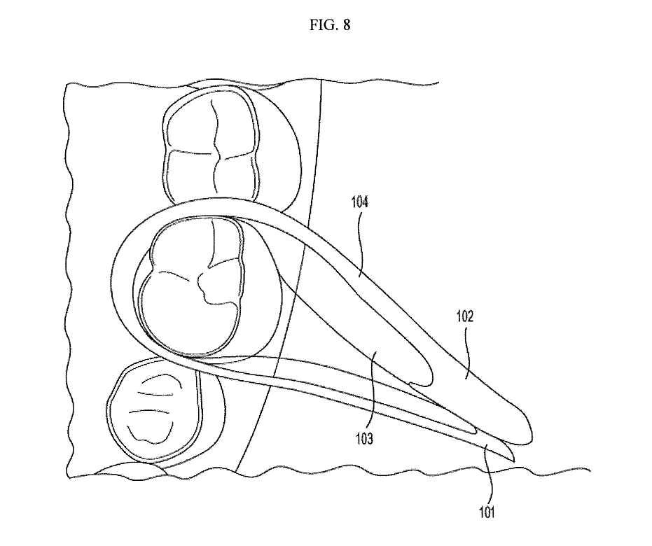

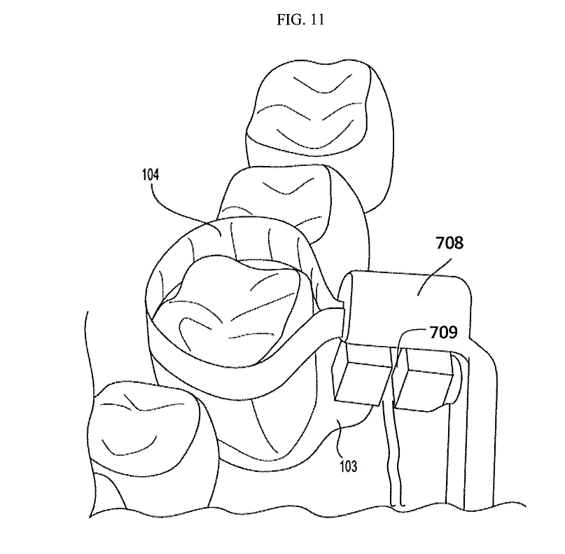

When the dental matrix band is bent to form a funnel-shaped loop with the interior faces of the first and second ends in contact with each other, the collar portion is the occlusal edge and is always placed toward the occlusal surface, and the bottom of the central portion is the gingival edge and is always placed toward the gum (FIGS. 8-12). The circumference of the occlusal edge is larger than the circumference of the gingival edge to accommodate the difference in tooth circumferences at the occlusal and gingival levels. The circumference of the occlusal edge may range from 1-5 cm, preferably 2-5 cm, more preferably 2.5-4 cm. The circumference of the gingival edge may range from 0.5-4.5 cm, preferably 1-4.5 cm, more preferably 1.2-3.6 cm, and may be 0.5-0.9 times the circumference of the occlusal edge, preferably 0.6-0.9 times, more preferably 0.8-0.9 times. In one embodiment, the collar portion comprises the abovementioned frictional engagement surface on the exterior side. The frictional engagement surface may cover up to 60%, preferably up 80%, more preferably up to 100% of the exterior face of the collar portion.

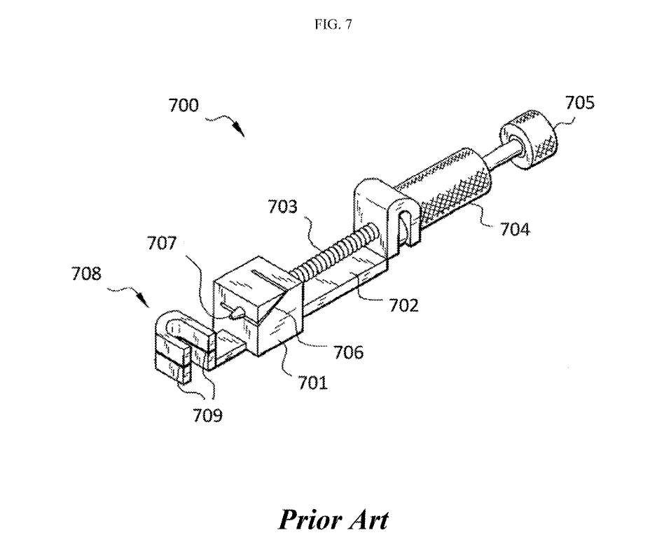

The dental matrix band may be used in connection with a TOFFLEMIRE Universal retainer 700, shown in FIG. 7, to position the dental matrix band around a tooth and to enable the dental matrix band to be used in filling a dental preparation (U.S. Pat. No. 2,439,703 issued to Tofflemire; and U.S. Pat. No. 5,460,525 issued to Rashid—each reference is incorporated in its entirety). The dental matrix band may also be used with retainers disclosed in U.S. Pat. No. 2,686,970 issued to Reiter; U.S. Pat. No. 2,687,573 issued to Stone; U.S. Pat. No. 2,709,302 issued to Reiter; U.S. Pat. No. 2,722,746 issued to Brenner; U.S. Pat. No. 3,425,125 issued to Bergendal; U.S. Pat. No. 3,516,162 issued to Ainsworth; U.S. Pat. No. 3,908,273 issued to Reiter; U.S. Pat. No. 4,824,365 issued to von Weissenfluh; U.S. Pat. No. 4,915,627 issued to Hirdes; U.S. Pat. No. 5,626,475 issued to von Weissenfluh and German Patent Document No. 2,603,130 A1. Each of these patent references is incorporated herein by reference in its entirety.

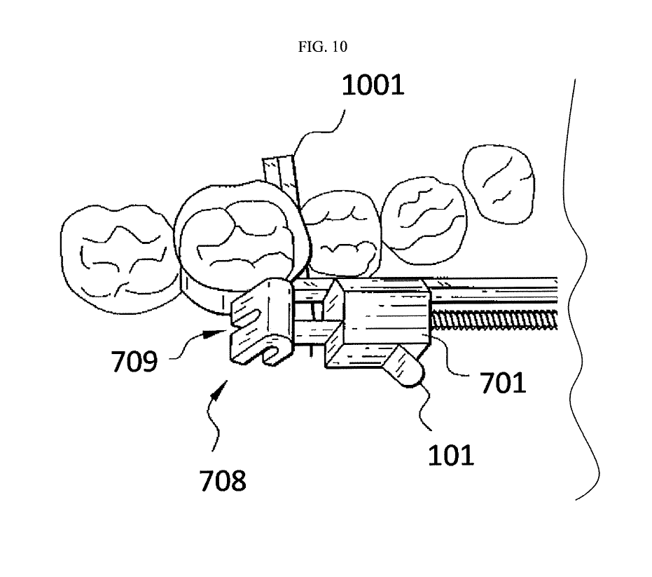

The TOFFLEMIRE Universal retainer has a connection block 701 slidably disposed on a rail member 702. The connection block is operatively connected with a threaded shaft 703 so that rotation of the inner and outer nuts 704, 705 can move the connection block along the rail member and then secure it in place. The connection block is formed with a slot 706 to receive the wedge-like first and second ends of the dental matrix band, and is provided with a pin 707 that stabilizes the dental matrix band when the first and second ends are disposed in the slot 706. The end of the rail 702 is provided with a U-shaped member 708, which is provided with slots 709 and is arranged to appropriately hold the dental matrix band in position in the manner depicted in FIGS. 10-12.

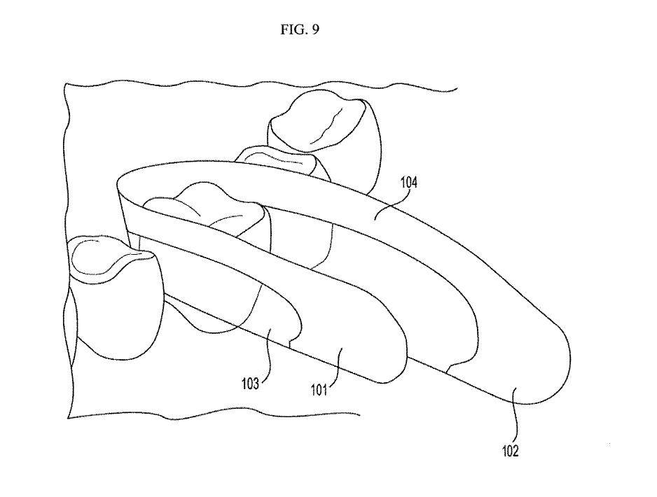

The dental matrix band can be placed interproximally before the etching and priming of a tooth to protect adjacent teeth from the etching/priming chemicals such as phosphoric acid. The dental matrix band is folded such that the interior faces of the first and second ends are touching each other to form a funnel-shaped loop (FIGS. 8 and 9). The smaller circumference of the dental matrix band is placed toward the gingiva. The dental matrix band should be seated around the tooth such that the occlusal portion of the dental matrix band extends 0.5-4 mm, preferably 1-3 mm, more preferably 1.5-2 mm above the marginal ridge of the adjacent tooth and the cavosurface margin to allow for proper placement of the composite restoration material in the marginal ridge area. The gingival portion of the dental matrix band may extend 0.1-1 mm, preferably 0.2-0.6 mm, more preferably 0.4-0.6 mm below the gingival cavosurface margin.

The first and second ends are being threaded via slot 709, and disposed in the slot 706 of the connection block in the manner depicted in FIG. 10. The wedge-like first and second ends of the dental matrix band project out of the slot 706 due to their increasing thickness, which produces an effect that tends to “wedge” them in a slip-free position and provide a bearing surface for a clamping screw securing the dental matrix band to the retainer. The collar portion threads through slots 709 and 706 and the thickness of the collar portion further ensures the dental matrix band does not slip and/or loosen when the dental band is tightened or when the restoration is in progress. Therefore, the wedge-like first and second ends of the dental matrix band and the collar portion facilitates the dental matrix band tightening procedure associated with the dental procedure in hand. The loops formed from the disclosed dental matrix band may be more stable than dental matrix bands with a uniform thickness.

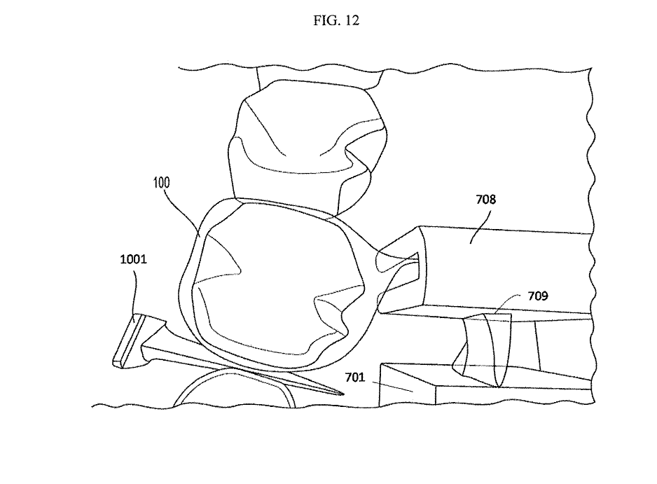

A wedge 1001 is illustrated in FIGS. 10 and 12, showing its disposition holding the dental matrix band in position once appropriately located and tightened about a tooth requiring dental work/restoration. The wedge is either triangular or round and made of wood or plastic. The wedge is inserted into the lingual embrasure to position the dental matrix band firmly against the gum margin of the preparation. The wedge helps to compress the dental matrix band against the tooth structure to create a tighter seal, preventing gingival overhang. And the wedge provides slight separation between the teeth, compensating for the thickness of the dental matrix band, and thus helping to create a tight contact between the finished restoration and the adjacent tooth.

Dental matrix bands having the aforementioned curvatures and sizes can also be advantageously assembled into kits that can be provided to dental practitioners. A kit comprising multiple-sized and shaped dental matrix bands is useful because the sizes and shapes of teeth can vary from patient to patient. By providing the kit with multiple embodiments of the dental matrix band, a practitioner is able to selectively use the dental matrix band that is most appropriately configured in size and shape to provide a desirable contour for restoring a particular tooth. These kits may also comprise the aforementioned dental matrix retainers.

1. A dental matrix band, comprising:
a first end and a second end, each comprising an interior face and an exterior face;
a central portion comprising transparent plastic disposed between the first end and the second end, wherein the central portion is elongated and inclined at an obtuse angle; and
a collar portion that connects the first end and the second end, wherein the collar portion borders a top of the central portion and extends in a parallel direction along the central portion, and the collar portion has a tapered thickness from a top of the collar portion to a shared border with the central portion;
wherein the tapered thickness of the collar portion decreases linearly from the top of the collar portion to the shared border with the central portion,
wherein the collar portion and the central portion have equivalent thicknesses at the shared border,
wherein the first end, the second end, the central portion, and the collar portion form a unitary construction when connected which tapers in a thickness from the first end and the second end to a middle of the central portion thereby producing a wedge-like configuration, and
wherein the dental matrix band is flexible and is configured to form a loop by connecting the interior faces of the first end and the second end and clamping the exterior faces of the first end and the second end by a dental matrix retainer.

2. (canceled)

3. The dental matrix band of claim 1, wherein the first end and the second end have a thickness ranging from 0.038 to 0.13 mm and a width ranging from 6 to 10 mm.

4. The dental matrix band of claim 1, wherein the exterior faces of the first end and the second end comprise a frictional engagement surface configured to securely attach the first end and the second end to a clamping screw of the dental matrix retainer.

5. The dental matrix band of claim 1, wherein the central portion has a tapered thickness from the first end and the second end to the middle of the central portion, the tapered thickness of the central portion ranges ranging from 0.0025-0.026 mm, a uniform width of the central portion ranges ranging from 6 to 10 mm, and a uniform longitudinal half-length of the central portion ranges ranging from 20 to 25 mm.

6. The dental matrix band of claim 1, wherein the obtuse angle ranges from 120 to 150°.

7. (canceled)

8. The dental matrix band of claim 1, wherein the collar portion further comprises an interior face, an exterior face, and a frictional engagement surface disposed on the exterior face.

9. The dental matrix band of claim 1, wherein the collar portion comprises a first curved portion connected to the first end of the dental matrix band and a second curved portion connected to the second end of the dental matrix band.

10. The dental matrix band of claim 1, wherein the collar portion has a width ranging from 1 to 5 mm, a half-length ranging from 20 to 25 mm, and a thickness ranging from 0.038 to 0.13 mm.

11. The dental matrix band of claim 10, wherein the collar portion has a width ranging from 1 to 3 mm.

12. The dental matrix band of claim 1, which has a longitudinal half-length of 25 to 35 mm.

13. The dental matrix band of claim 1, wherein the first end, the second end, and the collar portion comprise a biocompatible flexible plastic.

14. The dental matrix band of claim 13, wherein the biocompatible flexible plastic is polyester or nylon.

15. (canceled)

16. The dental matrix band of claim 1, which does not contain a metal.

17. The dental matrix band of claim 1, wherein the central portion comprises an interior face and an exterior face, and the central portion is flat between a middle of the central portion to the first end and the second end.

18. The dental matrix band of claim 1, wherein a bottom of the central portion is straight between a middle of the central portion to the first end and the second end.

19. A dental matrix kit, comprising:
a dental matrix retainer; and
the dental matrix band of claim 1.

20. The dental matrix band of claim 1, wherein the collar portion comprises a light-activated shape-memory polymer.

21. The dental matrix band of claim 4, wherein a surface roughness of the frictional engagement surface ranges from 0.01 to 50 μm.

22. The dental matrix band of claim 21, wherein the surface roughness ranges from 5 to 40 μm.

23. The dental matrix band of claim 4, wherein a roughness width of the frictional engagement surface ranges from 0.01 to 50 μm.
